(19) United States
(12) Patent Application Publication
(10) Pub. No.: US 2006/0254119 A1
(43) Pub. Date: Nov. 16, 2006

(54) Fishing lure with composite diving element

(75) Inventors: Juha Siirtola, Vierumiki (FI); Jukka Sairanien, Heinola (FI)

Correspondence Address: DORITY & MANNING, P.A., POST OFFICE BOX 1449, GREENVILLE, SC, 29602-1449, US

(73) Assignee: Normark Corporation

(21) Appl. No.: 11/128,499

(22) Filed: May 13, 2005

(51) Int. Cl. A01K 85/00

(52) U.S. Cl. 43/42.47

(57) ABSTRACT

A composite diving element for a fishing lure is generally disclosed. The diving element can be a diving plane that comprises a plate or a protective member along the leading edge of the diving element. The lure comprising the diving element and protective member combination can dive deeper than other previously known lures while remaining protected across the diving element's leading edge, enabling the lure to last longer.

### TECHNICAL FIELD OF THE INVENTION

The present invention relates to fishing lures. More specifically, the present invention relates to a fishing lure having a composite diving element allowing the lure to dive deeper while adding greater protection across the diving element's leading edge or surface.

### BACKGROUND OF THE INVENTION

Sport fishing is enjoyed around the world. From fresh water to salt water, a wide variety of fish species exist. Fishermen employ a variety of equipment and tackle depending upon the water being fished, the time of day, the species of fish sought, personal choice, and many other factors. A fishing lure, sometimes referred to as an artificial lure, is frequently a part of such equipment and tackle.

Fishing lures are typically designed and decorated with the goal of replicating or mimicking the movement and appearance of a food source for the particular fish being sought. For example, such lure may take on the shape of a minnow, tadpole, frog, mouse, insect, salamander, another fish, or such other food source. The fisherman's hope is that by having a lure closely resembling or acting like a source of food, fish will be enticed into biting the lure.

In an effort to make the lure aesthetically realistic, a designer can use materials pigmented with the desired colors. For example, colored plastics or rubber may be used. In addition, a designer can paint or stain the external surface of the lure to achieve the desired color and marking characteristics. Decorative features such as scales, eyes, and fins may be painted onto the surface or otherwise added to the lure.

Lures can also be designed with features that make the lure realistic in a functional manner. Fins, diving planes, spinners, rattles and the like may be added in order to make the lure move and sound like a food source. Some lures may be specifically designed to operate on the water surface while others may function only when below.

Generally speaking, the lure's overall shape, the weight of the lure, and the location of the point of attachment to the fishing line can affect the swim path of the lure during retrieval. Another factor is the lure's center of gravity. More specifically, the location of the center of gravity may affect the precision with which the lure can be cast as well as the movement of the lure as it is worked and retrieved by the angler.

Some lures are designed to swim at deeper depths than other lures. In fact, some lures can be classified as diving lures because of their tendency to dive at depths greater than about 5 feet. Some deep diving lures can reach depths of greater than about 10 feet upon retrieval. However, fishermen are constantly searching for diving lures that can dive deeper and can more quickly reach the desired depth. For instance, in some applications, a fisherman may desire a lure that dives to a depth of about 15 feet or more. As such, a need exists for a lure that can dive faster and deeper than other diving lures.

Also, because of these depths, diving lures are more susceptible to damage caused by the lure striking structures in the water, such as rocks and logs along the bottom of the body of water. Damage to the lure, especially to the diving element or plate typically present on a diving lure, can significantly affect the performance of the lure and cause the lure to not dive as deep and/or not swim properly. As such, a need also exists to better protect the lure, especially the diving element or plate of a diving lure, from damage that can adversely affect the performance of the lure.

In the past, deep diving lures have diving planes made out of either a plastic material or a metal material. However, both types of materials present certain disadvantages in their respective use. For example, a diving plane made from a plastic material relies almost exclusively on the performance of the diving plane to bring the lure to deeper depths. Also, a plastic diving plane can be easily damaged, especially on the leading edge, which can and does affect the performance of the diving plane. Alternatively, a metal diving plane can rely on both the weight of the diving plane and the performance of the diving plane to bring the lure to deeper depths. However, metal diving planes also present several disadvantages because an all metal diving plane is easily bendable, which can and does adversely affect the performance of the lure.

### BRIEF SUMMARY OF THE INVENTION

Objects and advantages of the invention will be set forth in part in the following description, or may be obvious from the description, or may be learned through practice of the invention.

The present invention generally provides for, in one embodiment, a fishing lure comprising a lure body having a head section, a diving element, and a protective member. The diving element is attached to the head section of the lure body and defines a top surface, a bottom surface, a beam, and a leading edge. The leading edge is opposite of the lure body and extends from the beam in a direction away from the lure body. The protective member is attached to the diving element and configured to cover at least a portion of the leading edge.

In some embodiments, the protective member defines a forward edge that is substantially parallel to the leading edge of the diving element. Also, in some embodiments, the protective member defines an aft edge that is substantially parallel to the leading edge of the diving element.

In yet other embodiments, the protective member is attached to the top surface of the diving plane and wraps around the leading edge so that at least some portion of the protective member is contacting both the top surface and the bottom surface of the diving element. In this embodiment, the protective member can be attached to the diving element by crimping the protective member around the leading edge so that the protective is attached at the top surface and the bottom surface of the diving element.

In other embodiments, the protective member is adhered to the top surface of the diving element. Alternatively, or in addition to, the protective member can define at least one aperture and the diving element can define at least one pin located on the top surface, such that the protective member is attached to the top surface of the diving plane by inserting the pin into the aperture.

In one embodiment, the diving plane can define a notch in which the protective element is partially inset so that at least a portion of the protective element extends beyond the leading edge of the diving plane.

In one particular embodiment, the diving element comprises a plastic material and the protective element comprises a metallic material.

In yet another embodiment, the present invention generally describes a fishing lure comprising a lure body having a head section, a diving plane, and a plate. The lure body is shaped to resemble a baitfish. The diving plane defines a top surface, a bottom surface, a leading edge, a trailing edge, and a beam. The trailing edge is attached to the head section of the lure body. The leading edge is opposite to the trailing edge and extends from the beam in a direction away from the lure body. The plate defines a forward plate edge and an aft plate edge that are both shaped to be substantially parallel to the leading edge of the diving plane. The plate is attached to the top surface of the diving plane so that the forward plate edge and the aft plate edge are substantially parallel to the leading edge of the diving plane and that the forward plate edge extends to at least the leading edge of the diving plane.

In yet another embodiment, the present invention generally provides for a fishing lure comprising a lure body having a head section, a diving plane, and a plate. The diving plane defines a top surface, a bottom surface, a leading edge, a trailing edge, and a beam. The trailing edge is attached to the head section of the lure body. The leading edge is opposite to the trailing edge and extends from said beam in a direction away from the lure body. The plate defines a first plate edge and a second plate edge. The first plate edge is attached to the top surface of the diving plane and configured so that the first plate edge is substantially parallel to the leading edge of the diving plane. The plate is wrapped around the leading edge of the diving plate so that the second plate edge is attached to the bottom surface of the diving plane.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which includes and makes reference to the appended figures, in which:

FIG. 1 is a perspective view of an embodiment of a lure according to the present invention;

FIG. 2 is a view of the opposite side of the embodiment of a lure illustrated in FIG. 1; FIGS. 3A-3C are exploded views of various embodiments of the present invention;

FIGS. 4A-4C are close-up views of various embodiments of the present invention; and

FIGS. 5A-5C are side, close-up views of various embodiments of the present invention.

Repeat use of reference characters throughout the present specification and appended drawings is intended to represent the same or analogous features or elements of the invention.

### DETAILED DESCRIPTION

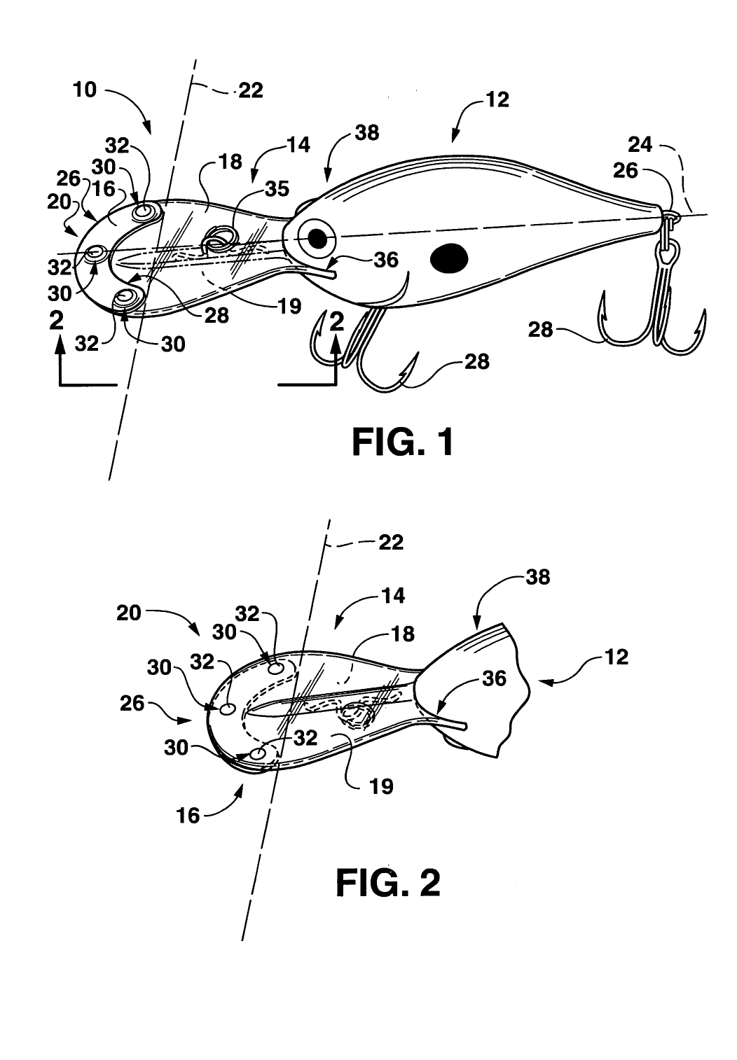

The present application generally provides for a fishing lure having a composite diving element allowing the lure to dive deeper while adding greater protection across the diving element's forward or leading edge. In order to fully understand the advantages of the present disclosure, FIGS. 1-5 will be explained in greater detail as exemplary embodiments of the present invention. Each example is provided by way of explanation of the invention, and not meant as a limitation of the invention. For example, features illustrated or described as part of one embodiment may be used with another embodiment to yield still a further embodiment. In fact, it will be apparent to those skilled in the art that various modifications and variations can be made in the present invention without departing from the scope or spirit of the invention.

Referring to FIG. 1, an exemplary embodiment of a fishing lure 10 according to the present invention is illustrated. The lure 10 includes a lure body 12, a diving element 14, and a protective member 16. Protective member 16 is attached to the top surface 18 of diving element 14. Protective member 16 is shown to contact leading or forward edge 20 of diving element 14.

In the exemplary embodiment of FIG. 1, the leading edge 20 of diving element 14 extends from beam 22 along the edge of diving plane 14 in a direction opposite the side of lure body 12. As used herein, “beam” means the widest portion of the diving element 14 in a direction that is substantially perpendicular to the longitudinal axis 24 of the lure body 12 and diving element 14.

By attaching protective member 16 to contact leading edge 20 of diving element 14, protective member 16 can effectively protect leading edge 20 of diving element 14 from damage which may occur while fishing the lure. Also, by only attaching protective member 16 to the leading edge of diving element 14, the center of gravity of lure 10 can be shifted farther toward the leading edge 20 of diving element 14. Thus, lure 10 can effectively dive to deeper depths more quickly than other lures previously known to one skilled in the art.

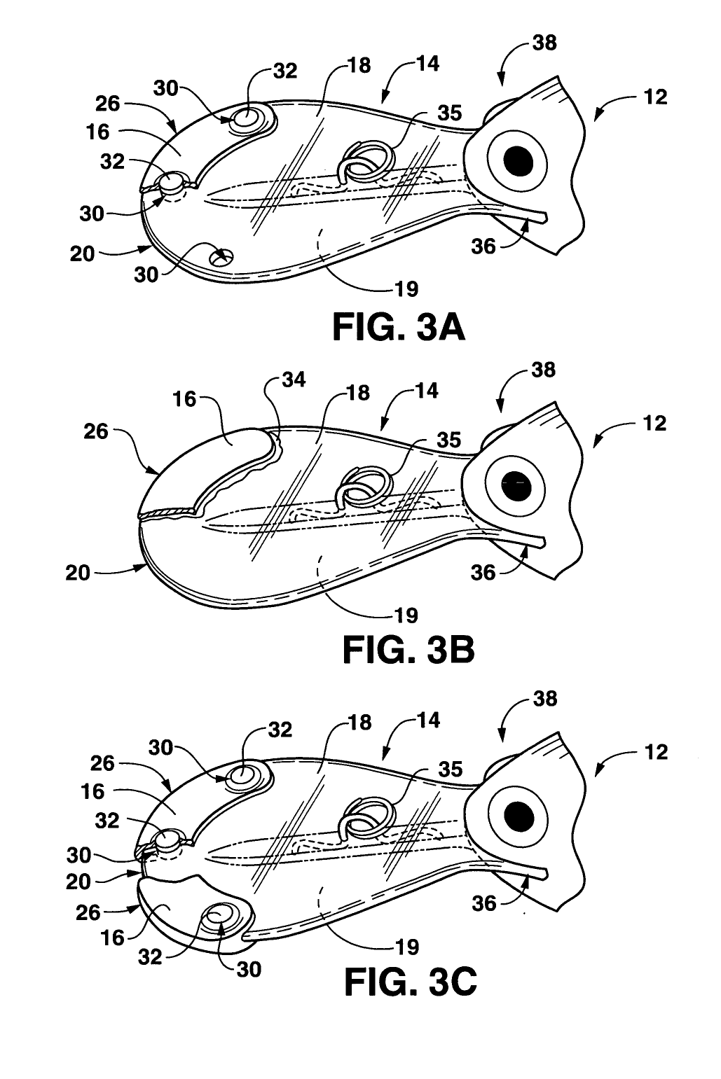

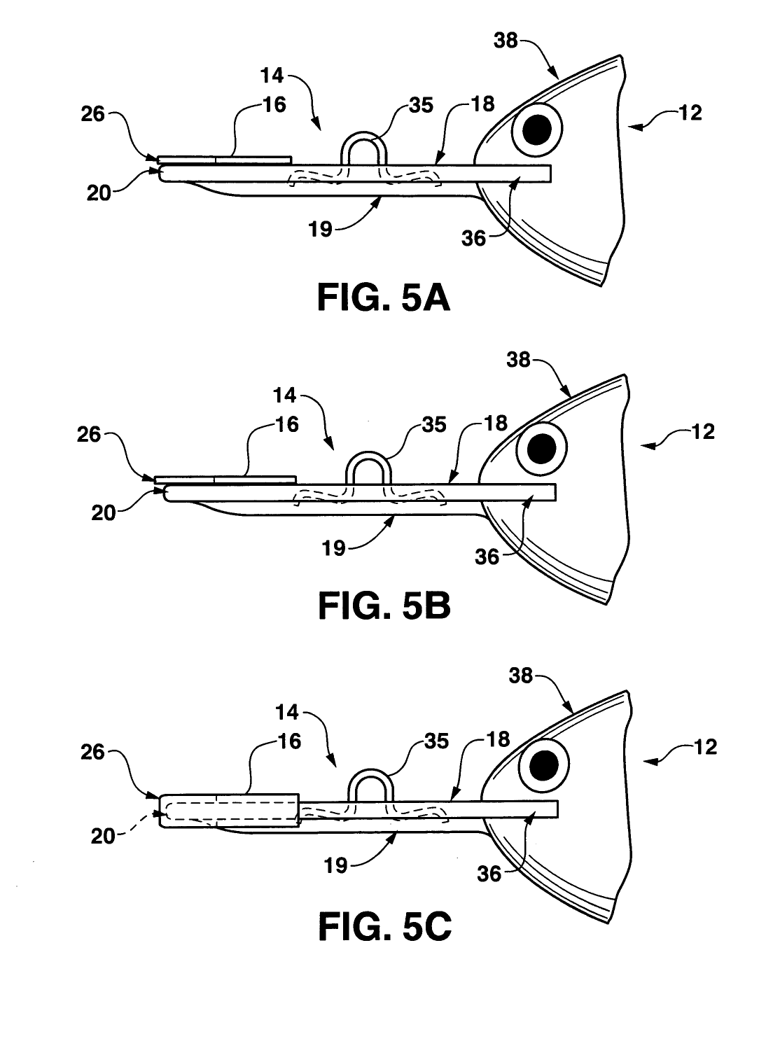

The exemplary embodiments illustrated in FIGS. 1 and 2 show forward edge 26 of protective member 16 shaped to be substantially parallel to the leading edge 20 of diving element 14. As shown in the exemplary embodiment of FIG. 5A, the forward edge 26 of protective member 16 is substantially flush with the leading edge 20 of diving element 14. However, the exact shape of the forward edge 26 of protective member 16 can be any shape that is capable of protecting and covering leading edge 20 of diving element 14 while still allowing lure 10 to swim properly while being fished. For example, in the exemplary embodiments depicted in FIGS. 3C and 5C, the protective member 16 wraps around leading edge 20 of diving element 14. Additionally, in other embodiments, such as the exemplary embodiment depicted in FIG. 5B, the forward edge 26 of protective member 16 extends beyond the leading edge 20 of diving element 14, so that the protective member 16 is situated in an offset position on the top surface 18 of diving element 14.

Also, the shape of the aft edge 28 of protective member 16 is shown in the exemplary embodiments of FIGS. 1-2 to be substantially parallel to the leading edge 20 of diving element 14. However, like the forward edge 26, the aft edge 28 of protective member 16 can be any shape that allows protective member 16 to protect and cover leading edge 20 of diving element 14 while still allowing lure 10 to swim properly while being fished.

Protective member 16, as shown in the exemplary embodiments of FIGS. 1-4, is shown to be a flat, plate-like member that is substantially shaped to be in plane with the top surface of diving element 14. However, the exact shape of protective member 16 can vary according to the desired performance of the lure 10.

Furthermore, protective member 16 can be made out of any material that is capable of protecting diving element 14. For example, in one particular embodiment, protective member 16 can comprise a metallic material. However, in other embodiments, the protective member 16 can comprise a plastic material, a rubber material, a woven material, or any other material that is capable of the specific performance desired while protecting diving element 14.

According to the present invention, protective member 16 is attached or secured to diving element 14. In the exemplary embodiment of FIGS. 1, 2, 3B-C, and 4A-C, protective member 16 is attached to diving element 14 by a pin and aperture combination. As shown, protective element 16 defines apertures 30. Also, diving element 14 defines pins 32 on top surface 18, allowing pins 32 to be inserted into apertures 30 to secure the protective member 16 to diving element 14. However, any method of attaching protective member 16 to diving element 14 can be utilized. For instance, in the exemplary embodiment of FIG. 3B, protective member 16 is adhered to diving element 14 by adhesive 34. In other exemplary embodiments depicted in FIGS. 3C and 3D, protective member 16 can be crimped to diving element 14, when protective member 16 wraps around leading edge 20 of diving element 14. In other embodiments, protective member 16 can be welded onto diving element 14, such as by ultrasonic welding. In yet other embodiments, protective member 16 can be partially inset into a notch defined by diving element 14, particularly the notch can be defined in the leading edge 20 of diving element 14. Also, any combination of means to attach protective member 16 to diving element 14 can be utilized. For instance, diving element 14 can be adhered to protective member 16, as well as secured to protective member 16 by a pin and aperture combination. By way of further example, diving element 14 can be molded around protective member 16 by placing protective member 16 into a mold and then injecting material for diving element 14 into the mold. As such, protective member 16 would still be positioned to protect diving element 14 in the final product and would be attached to diving element 14 due to the solidification and adherence of the injected material.

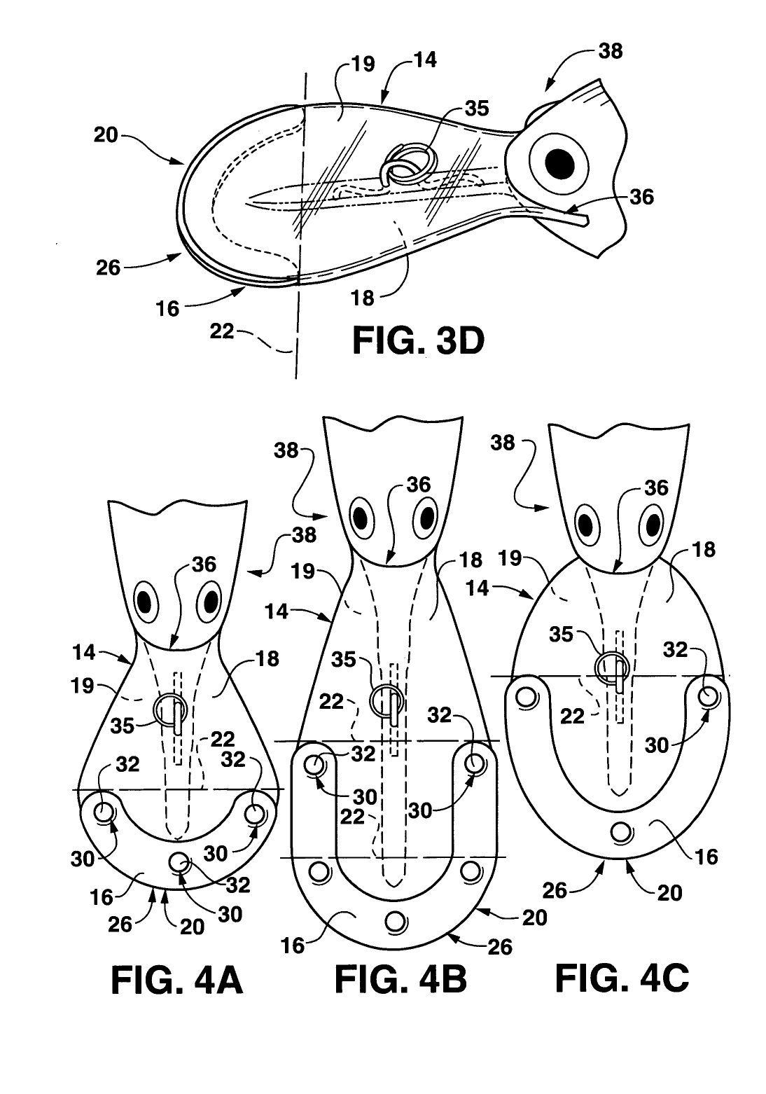

Diving element 14 is designed and shaped according to the particular performance and swim depth of lure 10. It should be appreciated that the size and shape of the diving element 12 may be configured in various combinations depending on the particular type and performance of the lure 10 desired. For example, FIGS. 4A-4C all depict various exemplary embodiments of the different shapes and sizes of diving element 14.

Diving element 14 can be constructed out of any material that is capable of being molded into the desired shape. For instance, in one embodiment, diving element 14 can comprise a plastic material. However, in other embodiments, protective element 16 can comprise a metallic material or a rubber-like material. For instance, in one particular embodiment, diving element 14 can comprise a plastic material, while protective element 16 comprises a metallic material.

In the exemplary embodiments of FIGS. 1-4, trailing edge 36 of diving element 14 is attached to head section 38 of lure body 12. According to the present invention, diving element 14 can be attached to lure body 12 by any means.

Lure body 12 can be designed to resemble a baitfish or other creature that may entice a targeted fish to bite. The lure body 12 can include any number or combination of ornamental features intended to provide the lure body 12 with a more realistic and life-like appearance. For example, the lure body 12 may be provided with scales, gills, fins, eyes, or other characteristics. As the lure is being retrieved through the water, diving element 24 drives the lure body 10 to a certain depth within the water. The depth to which the lure body 10 will travel is dependent upon variables such as the angle of plane 24 and the speed of the retrieve.

For this exemplary embodiment of the invention, lure body 12 is equipped with two hook loops 26 (one not shown) for attachment of treble hooks 28. FIG. 1 is only an example of the number and positioning of loops 26 and hooks 28. One or any number of various types of hooks may be positioned on lure body 12 as desired.

Also shown by way of example is line loop 35 for the attachment of fishing line to the diving element 14. Other mechanisms may be used in a variety of configurations and locations on diving element 14 or lure body 12 for attaching the line. Also, the placement of line loop 35 or any other means for securing a fishing line can vary according to the particular use and performance of lure 10. For instance, in some embodiments, line loop 35 or another means for securing a fishing line can be positioned on lure body 12, such as on head section 38. Alternatively, in other embodiments, line loop 35 or another means for securing a fishing line can be positioned anywhere on diving element 14, such as on top surface 18. In some other embodiments, line loop 35 or another means for securing a fishing line can be positioned on protective member 16.

While the present subject matter has been described in detail with respect to specific embodiments thereof, it will be appreciated that those skilled in the art, upon attaining and understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A fishing lure, comprising:
a lure body having a head section,
a diving element attached to said head section of said lure body, said diving element defining a top surface, a bottom surface, a beam, and a leading edge, said leading edge being opposite of said lure body and extending from said beam in a direction away from said lure body; and
a protective member attached to said diving element and configured to cover at least a portion of said leading edge.

2. The fishing lure of claim 1, wherein said protective member defines a leading edge that is substantially parallel to said leading edge of said diving element.

3. The fishing lure of claim 1, wherein said protective member defines an aft edge that is substantially parallel to said leading edge of said diving element.

4. The fishing lure of claim 1, wherein said protective member is attached to said top surface of said diving element and wraps around said leading edge so that at least some portion of said protective member is contacting both said top surface and said bottom surface of said diving element.

5. The fishing lure of claim 4, wherein said protective member is attached to said diving element by crimping said protective element around said leading edge so that said protective member is attached to said top surface and said bottom surface of said diving element.

6. The fishing lure of claim 1, wherein said protective element is adhered to said top surface of said diving element.

7. The fishing lure of claim 1, wherein said protective member further defines at least one aperture, and wherein said diving element further defines at least one pin located on said top surface, wherein said protective member is attached to said top surface of said diving element by inserting said at least one pin into said at least one aperture.

8. The fishing lure of claim 1, wherein said diving element defines a notch, said protective element being partially inset into said notch so that at least a portion of said protective element extends beyond said leading edge of said diving element.

9. The fishing lure of claim 1, wherein said diving element comprises a plastic material and said protective element comprises a metallic material.

10. A fishing lure, comprising:
a lure body having a head section, wherein said lure body is shaped to resemble a baitfish;
a diving plane defining a top surface, a bottom surface, a leading edge, a trailing edge, and a beam, said trailing edge being attached to said head section of said lure body, said leading edge being opposite to said trailing edge and extending from said beam in a direction away from said lure body; and
a plate defining a forward plate edge and an aft plate edge that are both shaped to be substantially parallel to said leading edge of said diving plane, said plate being attached to said top surface of said diving plane so that said forward plate edge and said aft plate edge are substantially parallel to said leading edge of said diving plane and said forward plate edge extending to at least to said leading edge of said diving plane.

11. The fishing lure of claim 10, wherein said plate is adhered to said diving plane.

12. The fishing lure of claim 10, wherein said diving plane further defines at least one post, and wherein said metal plate further defines at least one opening, and
said metal plate being attached to said diving plane by inserting said post defined by said diving plane into said opening defined by said metal plate.

13. The fishing lure of claim 10, wherein said plate is ultrasonically welded to said diving plane.

14. The fishing lure of claim 10, wherein said plate wraps around said forward edge of said diving plane so as to be attached to both said top surface and said bottom surface.

15. The fishing lure of claim 14, wherein said plate is crimped to said diving plane.

16. The fishing lure of claim 10 further comprising a ring attached to said top surface of said diving plane for attaching a fishing line to said diving plane.

17. The fishing lure of claim 10, wherein said forward plate edge of said plate extends past said leading edge of said diving plane, such that said plate is offset on said diving plane.

18. The fishing lure of claim 10, wherein said diving plane comprises a plastic material and said plate comprises a metallic material.

19. A fishing lure, comprising:
a lure body having a head section, said lure body being shaped to resemble a baitfish;
a diving plane, defining a top surface, a bottom surface, a leading edge, a trailing edge, and a beam, said trailing edge being attached to said head section of said lure body, and said leading edge being opposite to said trailing edge and extending from said beam in a direction away from said lure body; and
a plate defining a first plate edge and a second plate edge, said first plate edge being attached to said top surface of said diving plane and configured so that said first plate edge is substantially parallel to said leading edge of said diving plane, said plate being wrapped around said leading edge of said diving plate, and said second plate edge being attached to said bottom surface of said diving plane.

20. The fishing lure of claim 19, wherein said forward plate edge of said plate is substantially parallel to said leading edge of said diving plane.

21. The fishing lure of claim 19, wherein said diving plane comprises a plastic material and said plate comprises a metallic material.
